(19) United States
(12) Patent Application Publication
(10) Pub. No.: US 2016/0137478 A1
(43) Pub. Date: May 19, 2016

(54) OVERPRESSURE VALVE OF A SPEAR TUBE VALVE

(71) Applicant: MICRO MATIC A/S, Odense SV (DK)

(72) Inventor: Ken RIIS, Odense M (DK)

(21) Appl. No.: 14/903,176

(22) PCT Filed: Jul. 18, 2014
(86) PCT No.: PCT/EP2014/065492

§ 371 Date: Jan. 6, 2016

(30) Foreign Application Priority Data
Jul. 19, 2013 (EP) 13177220.4

(51) Int. Cl. B67D 1/08

(52) U.S. Cl. CPC B67D 1/0831; B67D 1/0845; B67D 1/0878

(57) ABSTRACT

The present invention relates to an extractor tube assembly for a beverage container, comprising a gas valve and a beverage valve adapted to cooperate with each other, the gas valve and beverage valve comprising a ring-shaped gasket, the gasket being made of an elastomeric material and comprising an insert made of a rigid material, and the gasket having a top part with an upper face visible from outside the extractor tube assembly, the top part being arranged above the insert. The elastomeric material encloses the insert and a portion of the top part of the gasket is adapted to be released from the insert when a pressure inside the beverage container exceeds a predetermined level so that fluid communication between an interior of the beverage container and the surroundings is provided, whereby the pressure is released from the beverage container, the gasket comprising an identification detectable from the upper face of the gasket, so that it is easily detectable if a pressure release function of the gasket has been partly or fully initiated.

### FIELD OF THE INVENTION

The present invention relates to an extractor tube assembly for a beverage container, to a beverage container comprising an extractor tube assembly, to a beverage dispensing system and to use of the identification of the gasket of the extractor tube assembly.

### BACKGROUND ART

Extractor tube assemblies are well known and are used in connection with beverage containers when beverage is to be dispensed.

When the beverage container is exposed to extreme heat, if there is a high hydraulic pressure inside the beverage container, if a gas regulator is defective or damaged, or if the beverage container is exposed to very low temperatures causing the beverage to freeze, the pressure inside the beverage container will increase, and thus, there is a risk of the components of the extractor tube assemblies being shot out of the beverage container like a projectile with the severe risk that the components damage equipment or people.

A solution is known from WO 95/23112 in which a safety system is incorporated in the packaging to prevent the valve plug from being shot out of the beverage container. This system works, but there is a need for an improved solution to the problem.

### SUMMARY OF THE INVENTION

It is an object of the present invention to wholly or partly overcome the above disadvantages and drawbacks of the prior art. More specifically, it is an object to provide an improved extractor tube assembly.

The above objects, together with numerous other objects, advantages and features, which will become evident from the below description, are accomplished by a solution in accordance with the present invention by an extractor tube assembly for a beverage container, comprising a gas valve and a beverage valve adapted to cooperate with each other, the gas valve and beverage valve comprising a ring-shaped gasket, the gasket being made of an elastomeric material and comprising an insert made of a rigid material, and the gasket having a top part with an upper face visible from outside the extractor tube assembly, the top part being arranged above the insert,

wherein the elastomeric material encloses the insert and a portion of the top part of the gasket is adapted to be released from the insert when a pressure inside the beverage container exceeds a predetermined level so that fluid communication between an interior of the beverage container and the surroundings is provided, whereby the pressure is released from the beverage container, the gasket comprises an identification detectable from the upper face of the gasket so that it is easily detectable if a pressure release function of the gasket has been partly or fully initiated.

By implementing the identification in connection with the gasket, it is obtained that information regarding the gasket and the degassing function and security provided by the insert is always available. In addition, by incorporating the detectable identification on or in the gasket, it is possible for the user of the extractor tube assembly to easily detect if the degassing function of the gasket has been partly or fully initiated. This is due to the fact that before the gasket releases pressure, it will slightly change to a shape which may be detectable via the identification since the identification changes its original shape during the degassing function, whereby the user may easily detect that the gasket, and thereby the beverage container, needs to be replaced. The overall security of the extractor tube assembly is thereby enhanced. Furthermore, if the identification discloses or indicates a time, it is possible to detect when the extractor tube assembly has been incorporated into the beverage container. Other information may be incorporated into the identification as well. Furthermore, the identification may have the function of indicating if the gasket has been exposed to a large internal pressure in the beverage container in that the identification may be adapted to visually disclose this.

In an embodiment, the identification may be visible.

Furthermore, the identification may be a circle line arranged on or in the upper face of the gasket, or a plurality of graphical elements may provide a circle which is easily detectable from the upper face.

Moreover, the identification may have a color which is different from a color of the gasket in order to facilitate detection of the identification.

In addition, the identification may be part of the upper face.

Also, the identification may be embedded in the upper face.

Further, the gasket may have a color which is the identification of the gasket.

Additionally, the identification may be pictograms, geometrical signs, impressions, numbers or characters arranged on the upper face.

Moreover, the gasket may comprise an RFID-tag.

Also, the identification may comprise detectable elements, such as protections or grooves, arranged on the upper face of the gasket.

In addition, the elastomeric material may be ethylene propylene diene monomer (EPDM).

Furthermore, the rigid material may be stainless steel.

In an embodiment, the insert may comprise a first tubular part extending in the axial direction of the gasket and a flange ring-shaped part extending radially from the tubular part towards a center of the insert, ending at an inner periphery, providing an open area around the center, the ring-shaped part comprising a plurality of incisions arranged around the inner periphery.

Furthermore, the ring-shaped part may comprise six first incisions and one second incision, the second incision being at least three times bigger than one of the first incisions, all the first and second incisions being arranged around the inner periphery.

Also, the tubular part may have an outer face comprising one or more projections.

In addition, the extractor tube assembly may be an A, G, S, D, M or U system, preferably a D system.

The present invention furthermore relates to a beverage container comprising an extractor tube assembly as described above.

The present invention also relates to a beverage dispensing system comprising:
a beverage container having an extractor tube assembly as described above,
a dispense head adapted to be connected with the extractor tube assembly,
a gas supply being connected to the dispense head for supplying gas to the beverage container, and
a dispensing tap being connected with the dispense head via a dispensing line.

Furthermore, a detector device may be adapted to detect the identification of the gasket and to receive information regarding the identification, and a processing device may be adapted to extract the information regarding the identification to provide the information to a user.

In an embodiment, the detector device may be connected with a communication unit which is adapted to communicate with a storage device, such as a server.

Finally, the present invention relates to use of the identification of the gasket of the extractor tube assembly as described above for controlling that the pressure release function of the gasket has not been partly or fully initiated.

### BRIEF DESCRIPTION OF THE DRAWINGS

The invention and its many advantages will be described in more detail below with reference to the accompanying schematic drawings, which for the purpose of illustration show some non-limiting embodiments and in which

FIG. 1 shows an extractor tube assembly according to the invention,

FIG. 2 shows the extractor tube assembly of FIG. 1 in a top view,

FIG. 3 shows a gasket in a perspective view,

FIG. 4 shows the gasket with the insert partly visible,

FIG. 5 shows the gasket from the bottom,

FIG. 6 shows the gasket after it has released pressure,

FIGS. 7a to 7h show different embodiments of identifications on different types of gaskets,

FIG. 8 shows the gasket in a partly cross-sectional side view,

FIG. 9 shows the gasket of FIG. 8 in a top view,

FIG. 10 shows a cross-sectional view of the gasket along the A-A line in FIG. 9,

FIG. 11 shows a cross-sectional view of the gasket along the B-B line in FIG. 9,

FIG. 12 shows a cross-sectional view of the gasket along the E-E line in FIG. 10,

FIG. 13 shows an enlarged area C of FIG. 10,

FIG. 14 shows the insert in a side view,

FIG. 15 shows the insert in a top view,

FIG. 16 shows the insert of FIG. 15 in an enlarged top view,

FIG. 17 shows a cross-sectional view of the insert along the A-A line in FIG. 16,

FIG. 18 shows a cross-sectional view of a beverage container with the extractor tube assembly and a dispense head,

FIG. 19 shows a dispensing system,

FIGS. 20-21 show diagrams of degassing situations where the beverage container is exposed to extremely high temperatures and where the beverage container has a high hydraulic pressure, and

FIG. 22 shows a cross-sectional view of another beverage container with the extractor tube assembly and a dispense head.

All the figures are highly schematic and not necessarily to scale, and they show only those parts which are necessary in order to elucidate the invention, other parts being omitted or merely suggested.

### DETAILED DESCRIPTION OF THE INVENTION

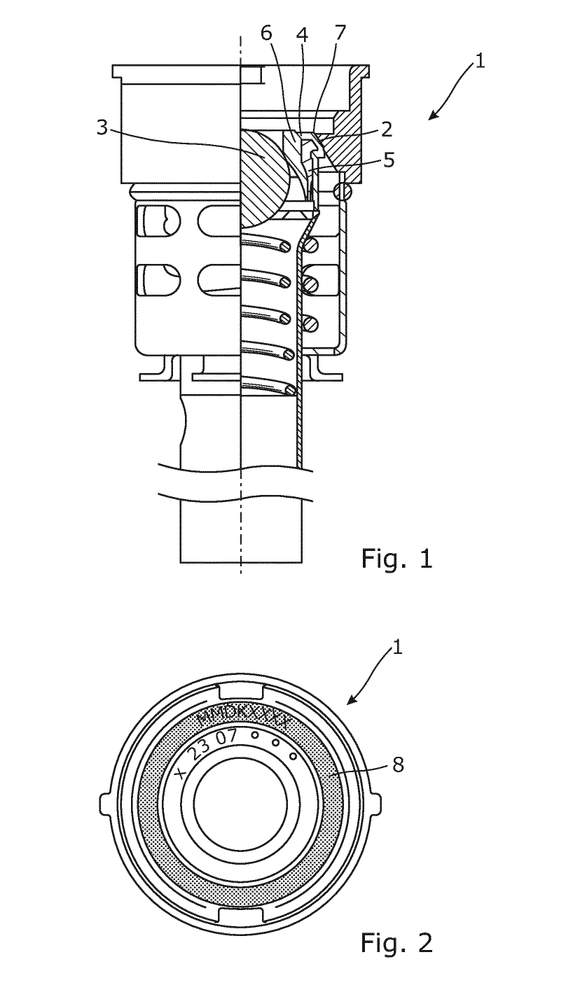

In FIG. 1, an extractor tube assembly 1 for a beverage container is shown. The extractor tube assembly comprises a double valve having a gas valve 2 and a beverage valve 3 adapted to cooperate with each other. The function of the double valve is well known and will thus not be described further. The extractor tube assembly shown in FIG. 1 is a well type system known as a D-system. The gas valve 2 and beverage valve 3 comprise a ring-shaped gasket 4, the gasket 4 being made of an elastomeric material and comprising an insert 5 made of a rigid material. The gasket 4 has a top part 6 with an upper face 7 visible from outside the extractor tube assembly, and the top part 6 is arranged above the insert 5.

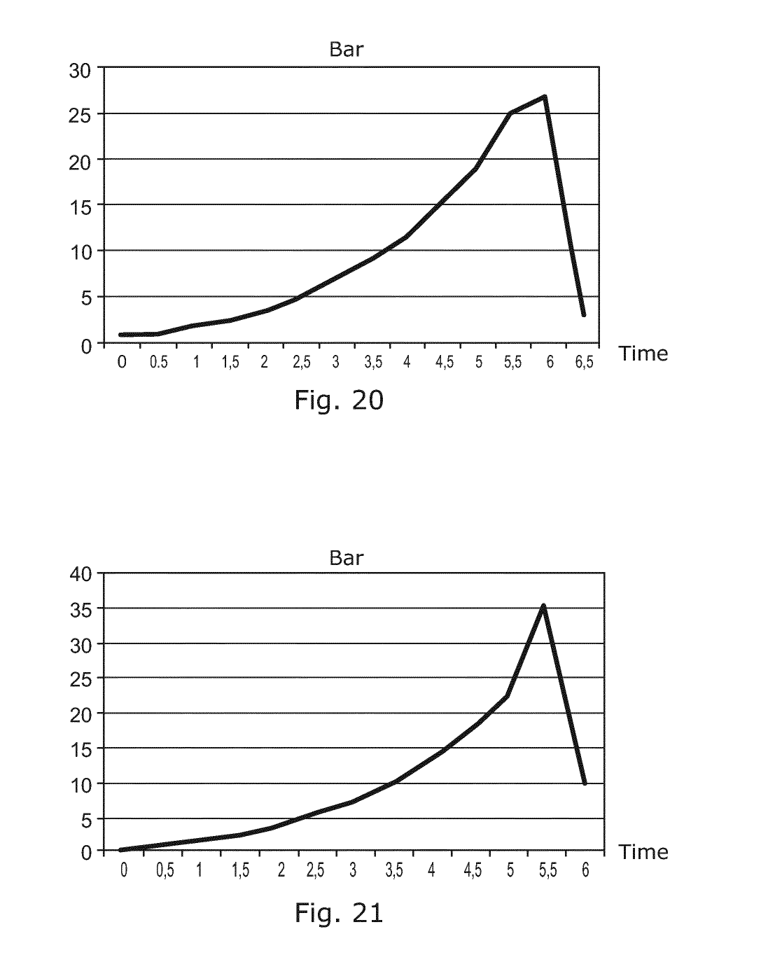

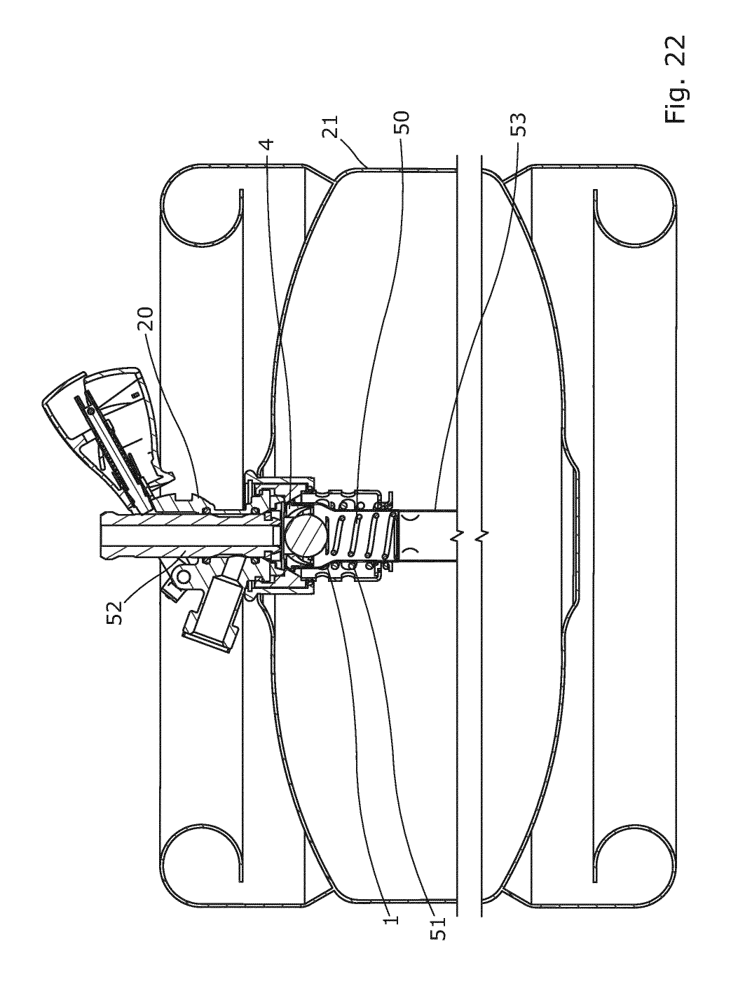

Furthermore, the top part 6 of the gasket 4 is adapted to be released from the insert 5 when a pressure inside the beverage container (not shown) exceeds a predetermined level, so that fluid communication between an interior of the beverage container and the surroundings is provided, whereby the pressure is released from the beverage container. The predetermined level will be described further below in connection with FIGS. 20-21. In addition, the gasket comprises an identification (not shown in FIG. 1) detectable from the upper face 7 of the gasket.

In FIG. 2, the extractor tube assembly 1 is shown from above, and the identification 8 is visible. In this embodiment, the identification 8 is a circle line arranged on the upper face of the gasket. Advantageously, the identification has a color which is different from the color of the gasket, or at least from the color of the upper face of the gasket. By implementing the identification in connection with the gasket, it is obtained that information regarding the gasket and the degassing function and security provided by the insert is available for the user at any time. Furthermore, if the identification discloses or indicates a time, it is possible to detect when the extractor tube assembly has been incorporated into the beverage container. The manufacturer of the extractor tube assemblies may make the gasket in different colors depending on the year in which they are made, whereby the color itself also may indicate which year the gasket has been made and incorporated in the extractor tube assembly. Other information may be incorporated in the identification as well. The identification 8 shown in FIG. 2 has a supplier label and may have a year stamp.

Furthermore, the identification 8 also has the function of indicating if the gasket has been exposed to a large internal pressure in the beverage container in that the identification may be adapted to visually disclose this. To this effect, it is important that the identification has a geometrical shape which is easily detectable, such as a circle, and that it is part of the upper face of the gasket. This is due to the fact that before the gasket releases pressure, it will slightly change to a shape which may be detectable via the identification, whereby the user easily may detect that the gasket, and thereby the beverage container, needs to be replaced. The overall security of the extractor tube assembly is thereby enhanced.

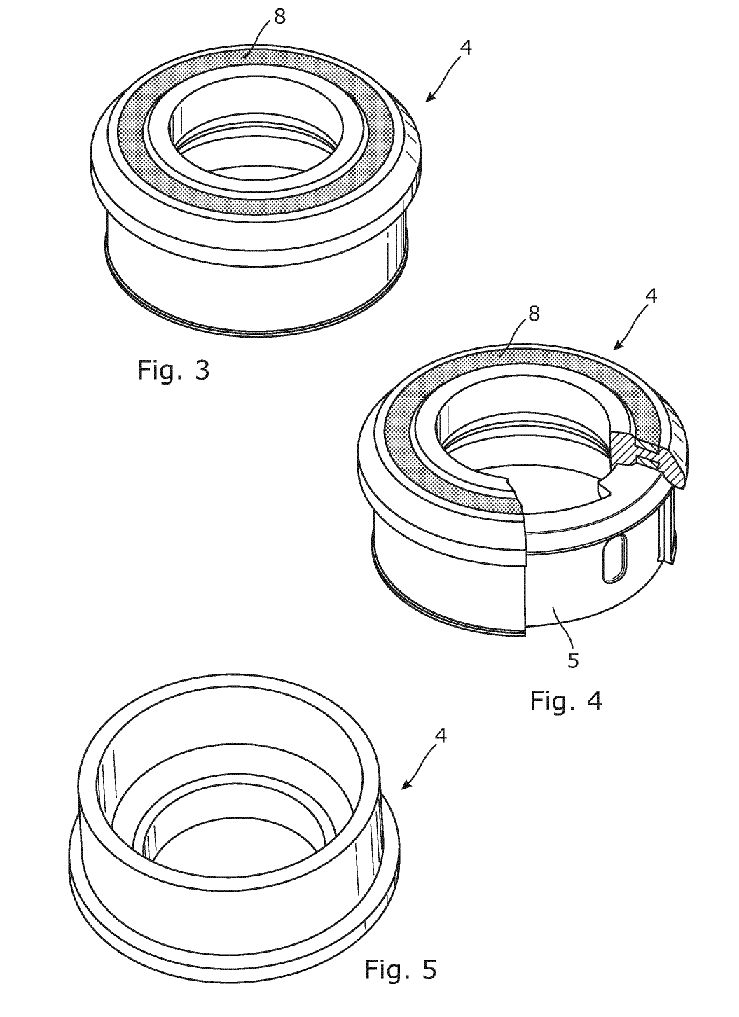

FIGS. 3 to 5 show a gasket 4 having the identification 8 in the form of a circle. FIG. 4 also shows part of the gasket being removed so that the insert 5 is visible. The insert will be described further below. However, it is preferably made of stainless steel. The gasket is preferably made of ethylene propylene diene monomer (EPDM) and completely encloses the insert, which minimises, or preferably completely eliminates, the risk of chemical attacks on the bonding between the gasket and the insert. The gasket completely enclosing the insert in the gasket also enhances the hygiene. In FIG. 5, the gasket 4 is shown in a bottom view, and it is easily deducible that the insert is completely enclosed in the gasket.

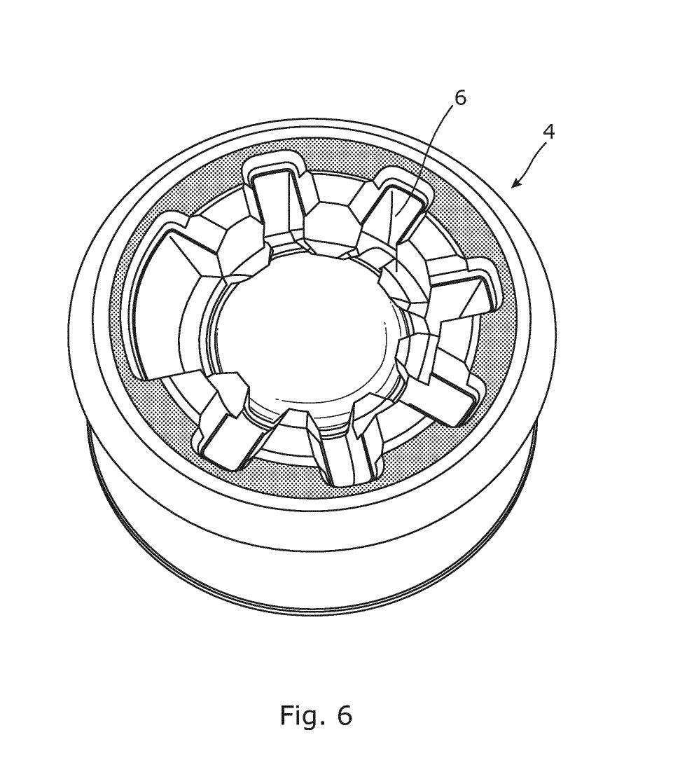

In FIG. 6, the gasket 4 is shown after is has released pressure in that a portion of the top part 6 of the gasket 4 is adapted to be released from the insert (not shown) when a pressure inside the beverage container (not shown) exceeds a predetermined level causing the pressure to be released from the beverage container. At the left side of the gasket 4 it is shown how gas is released through the gasket.

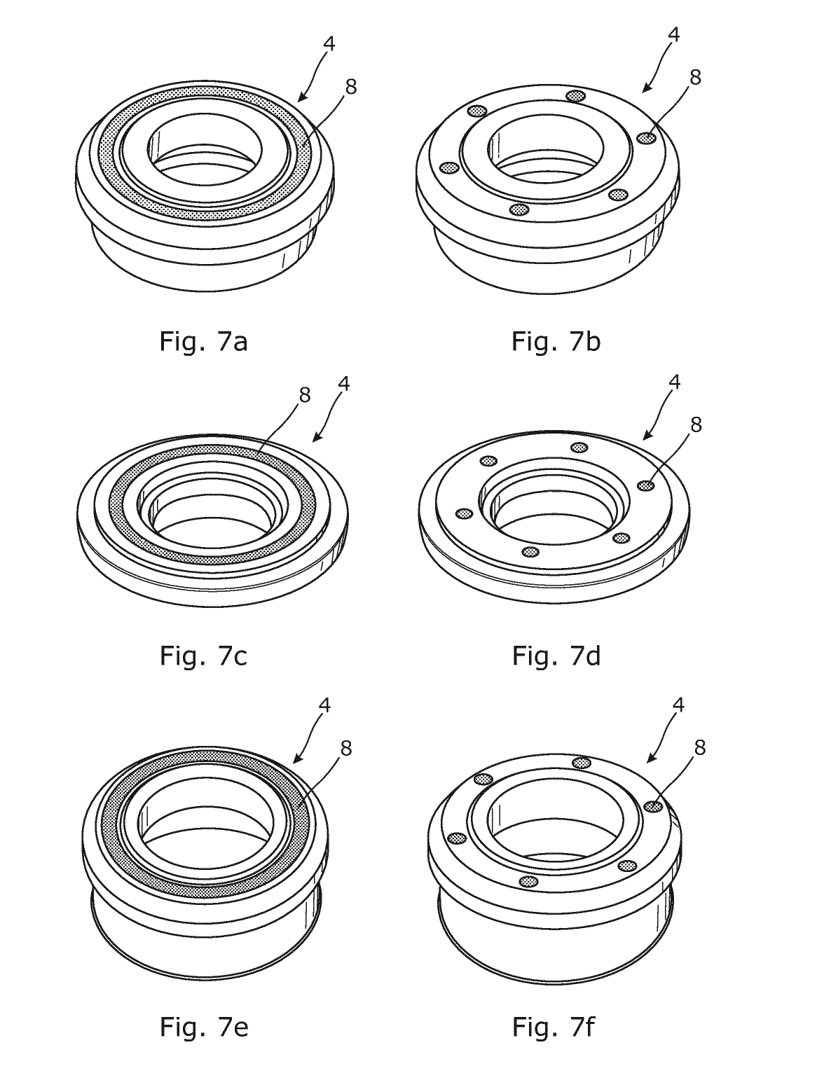

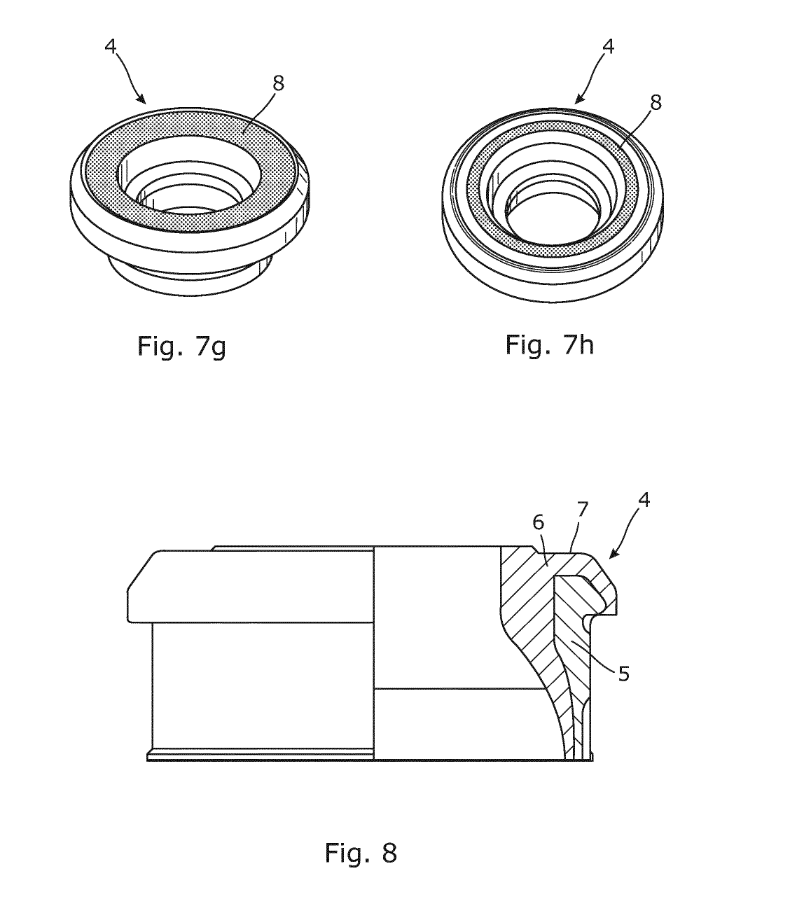

FIGS. 7a to 7h show different embodiments of identifications arranged on the upper face of the gasket. Furthermore, different design and types of gaskets are shown, which may be incorporated into different extractor tube systems, which will be appreciated by a person skilled in the art. FIGS. 7a, 7c and 7e all have circular identifications. FIGS. 7b, 7d and 7f all have a plurality of circular dots arranged around the upper face. FIGS. 7g and 7h show other embodiments of the gaskets where the identifications 8 occupy a larger area of the upper face. The identification may have other shapes and designs.

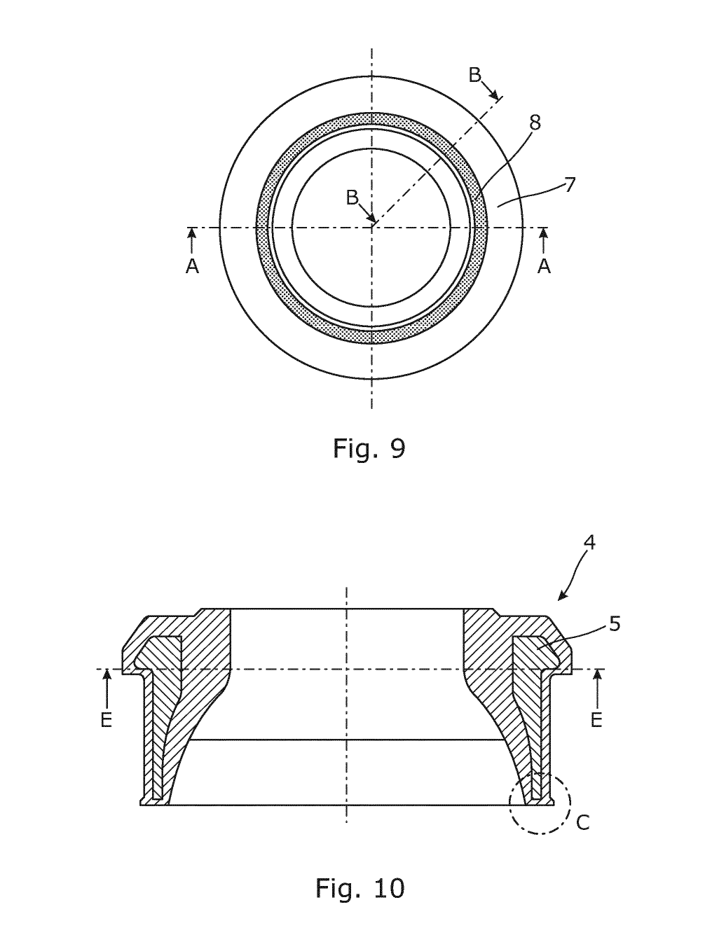

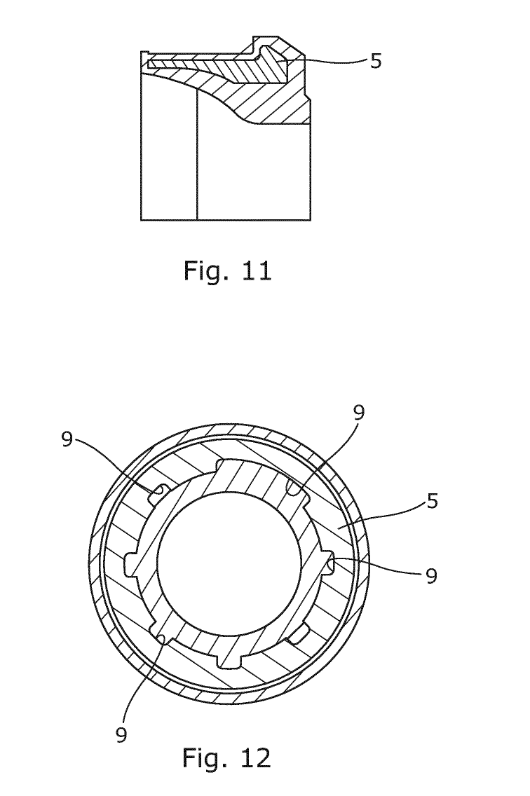

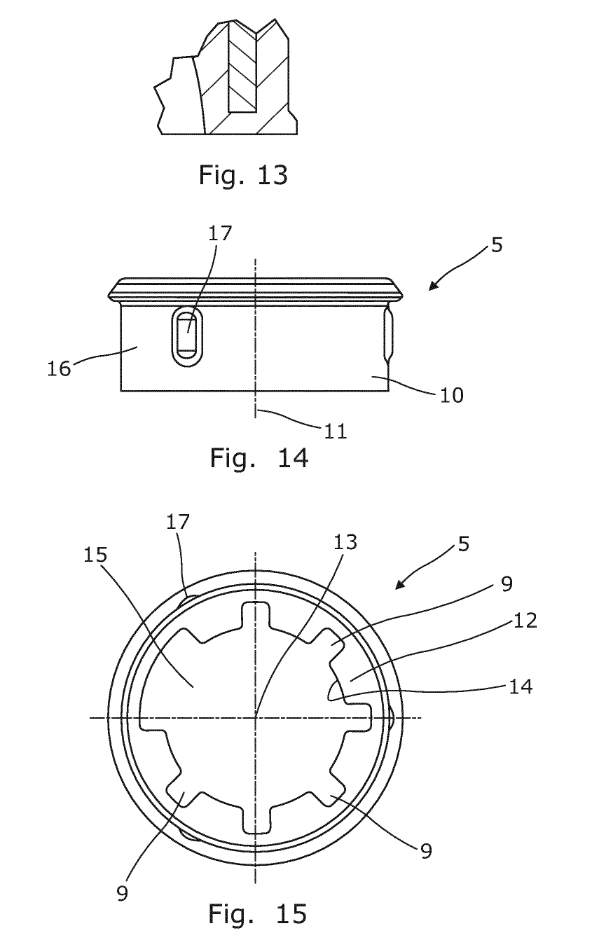

In FIGS. 8 to 13, the gasket 4 is shown in different views and cross-sections. In FIG. 8, the gasket 4 is shown in an outside side view (left side) and partly in a cross-sectional view (right side). The gasket 4 encloses the insert 5 and has a top part 6 and the upper face 7. FIG. 9 shows the gasket 4 in a top view where the identification 8 is a circle extending around the upper face 7. FIG. 10 shows a cross-sectional view along the A-A line in FIG. 9, and again, it is shown how the gasket completely encloses the insert 5. FIG. 11 shows another cross-sectional view along the B-B line in FIG. 9. In FIG. 12, a cross-sectional view along the E-E line of FIG. 10 shows the configuration of the insert 5 having a plurality of incisions 9. FIG. 13 shows an enlarged area C of FIG. 10.

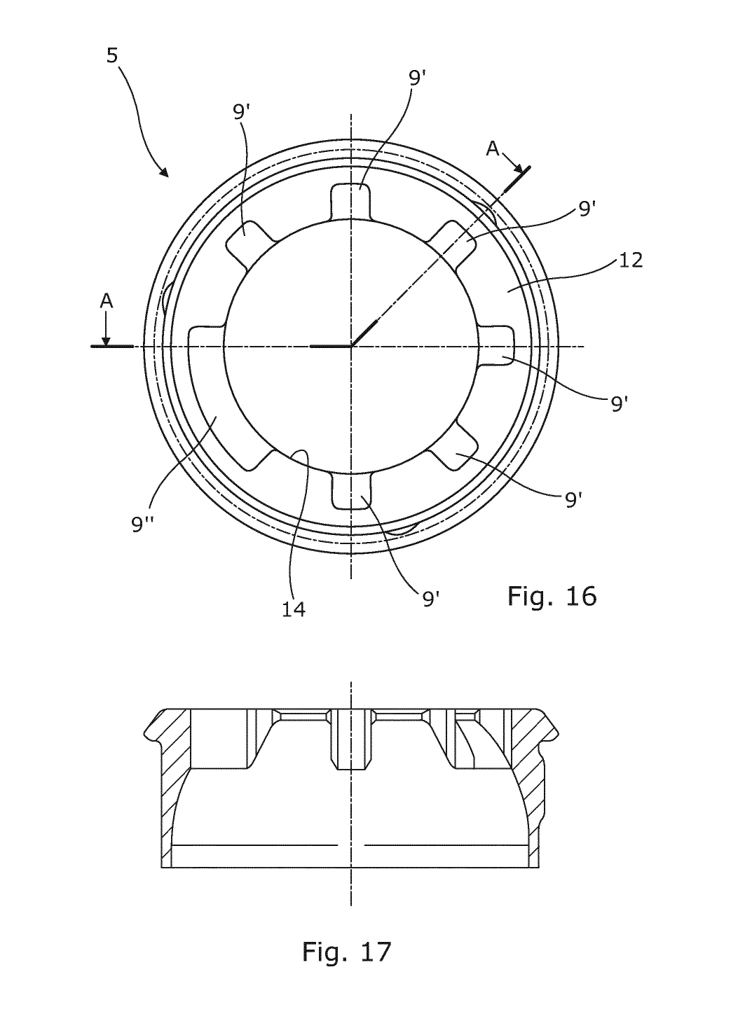

In FIG. 14, the insert 5 is shown. The insert 5 comprises a first tubular part 10 extending in the axial direction 11 of the gasket and a flange ring-shaped part 12, shown in FIG. 15, extending radially from the tubular part towards a center 13 of the insert, ending at an inner periphery 14, providing an open area 15 around the center. The ring-shaped part 12 comprises a plurality of incisions 9 arranged around the inner periphery 14. The tubular part 10 has an outer face 16 comprising one or more projections 17. In the shown embodiment, the insert comprises three projections 17 arranged around the outer face with a mutual distance between them. The projections 17 are adapted to assist in positioning the gasket in the extractor tube assembly. As shown in FIG. 16, in this embodiment of the insert 5, the ring-shaped part 12 comprises six first incisions 9′ and one second incision 9″, the second incision 9″ being at least three times bigger than one of the first incisions 9′, all first and second incisions 9′, 9″ being arranged around the inner periphery 14. The second incision 9″ assists in the pressure release function of the gasket. FIG. 17 shows a cross-sectional view along the A-A line of FIG. 16.

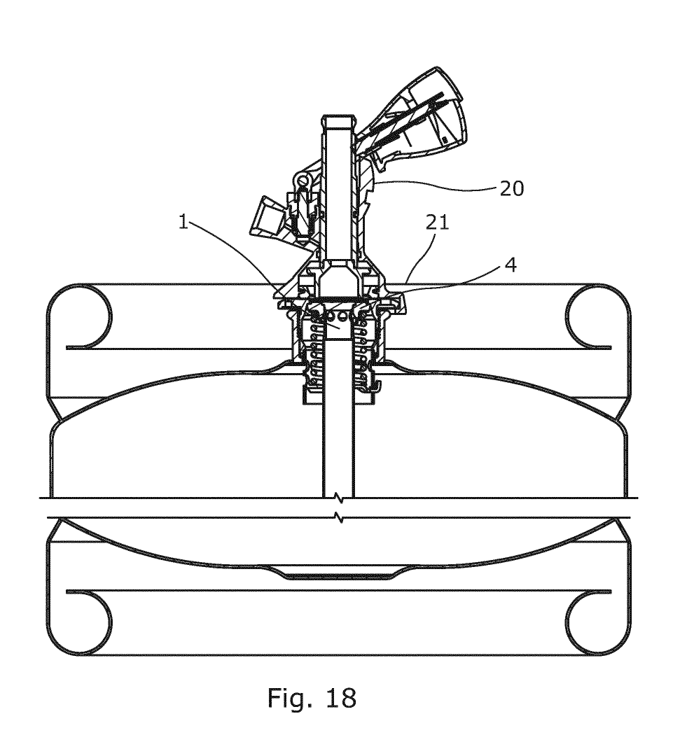

FIG. 18 shows a cross-sectional view of a dispense head 20 being mounted on a beverage container 21, the container 21 only being partly shown. The extractor tube assembly 1 is arranged in the container 21. The extractor tube assembly shown in FIG. 18 is another embodiment than that shown in FIG. 1. The function of the extractor tube assembly 1 is well known and will not be described in detail. However, the extractor tube assembly 1 is adapted to function as a valve and has an internal spring having a spring force enabling the opening of the beverage container to be kept closed. When the dispense head is connected to the extractor tube assembly 1 and is activated (in FIG. 18, the dispense head is not activated), the piston of the dispense head presses the gasket 4 of the extractor tube assembly 1 downwards, which causes the extractor tube assembly to open. This may cause the beverage in the beverage container 21 to be forced out of the container at the bottom via the down tube of the extractor tube assembly 1 when the pressurised gas, i.e. CO2, is supplied to the area above the beverage.

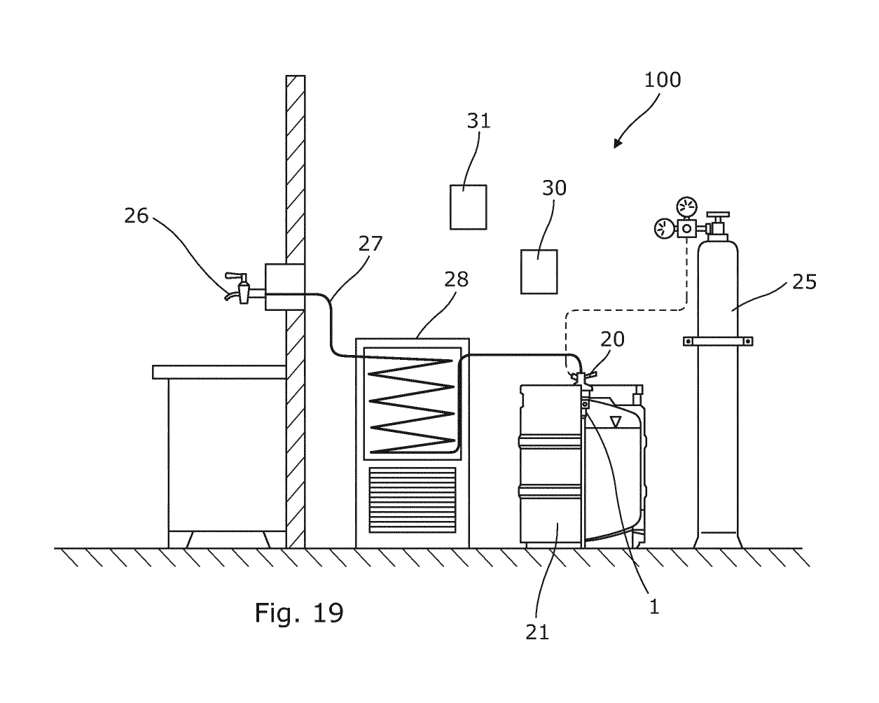

FIG. 19 shows a beverage dispensing system 100. The beverage dispensing system 100 comprises a beverage container 21, such as a keg. The beverage container 21 comprises the extractor tube assembly 1 arranged in an opening (not shown) of the beverage container 21.

The beverage dispensing system 100 also comprises a gas supply 25. The gas supply 25 may for instance be a CO2 cylinder and may be connected to a dispense head 20.

A dispensing tap 26 is connected to the dispense head 20 via a dispensing line 27. In this embodiment, a cooling device 28 is arranged between the dispensing tap 26 and the dispense head 20 to cool the beverage before dispensing.

During operation of the beverage dispensing system 100, the gas supply 25 supplies pressurised gas, such as CO2 or other suitable gasses, via the dispense head 20 to the top of the beverage container 21 in order to displace the beverage. When the dispensing tap 26 is opened, the CO2 will start displacing the beverage from the top of the beverage container 21, causing the beverage at the bottom of the beverage container 21 to flow via the extractor tube assembly into a flow channel in the dispense head 20 and further into the dispensing line 27.

The beverage dispensing system 100 may also comprise a detector device 30 adapted to detect the identification of the gasket and to receive information regarding the identification, and a processing device 31 adapted to extract the information regarding the identification to provide the information to a user. The detector device may for instance be a color detector.

Furthermore, the detector device is connected with a communication unit which is adapted to communicate with a storage device, such as a server. The server may contain information regarding the identification, whereby the user may receive the necessary information about the gasket immediately after detection of the identification and in this way be able to make a decision about maintenance, cleaning and/or replacement of the gasket.

FIGS. 20-21 show diagrams of degassing situations where the beverage container is exposed to extremely high temperatures and where the beverage container has a high hydraulic pressure. The safety system of the gasket will prevent accidents from happening in case a beverage container is pressurised to a level which exceeds the burst point of the beverage container. If the internal beverage container pressure exceeds around 35 bar (574 PSI), the top part of the gasket (as seen in FIG. 6) will be released from the insert and will release the pressure from the beverage container. As mentioned earlier, the high pressure may be caused by a defective regulator, hydraulic pressure of the beverage in the beverage container, heating or freezing of the beverage container.

FIG. 22 shows a cross-sectional view of another dispense head 20 being mounted on a beverage container 21, the beverage container 21 only being partly shown.

The extractor tube assembly 1 is arranged in the container 21. The dispense head 20 and extractor tube assembly 1 shown in FIG. 22 are of the D-system type. The function of the extractor tube assembly 1 is well known and will not be described in detail. However, the extractor tube assembly 1 is adapted to function as a gas valve and a beverage valve cooperating with each other as a double valve. The double valve has internal springs 50, 51 having spring forces enabling the opening of the beverage container 21 to be kept closed, since the valve seats of the beverage valve and the gas valve are pressed upwards, thereby closing the valve. When the dispense head 20 is connected to the extractor tube assembly 1 and is activated (in FIG. 22, the dispense head 20 is not activated), the piston 52 of the dispense head presses the gasket 4 of the extractor tube assembly 1 downwards, which causes the extractor tube assembly 1 to open. This causes the beverage in the beverage container 21 to be forced out of the container at the bottom via the down tube 53 of the extractor tube assembly 1 when the pressurised gas, i.e. CO2, is supplied to the area above the beverage. The beverage is then led through the hollow piston 52 of the dispense head 20 and therefrom into a dispensing line (not shown).

Although the invention has been described in the above in connection with preferred embodiments of the invention, it will be evident for a person skilled in the art that several modifications are conceivable without departing from the invention as defined by the following claims.

1. An extractor tube assembly for a beverage container, comprising a gas valve and a beverage valve adapted to cooperate with each other, the gas valve and beverage valve comprising a ring-shaped gasket, the gasket being made of an elastomeric material and comprising an insert made of a rigid material, and the gasket having a top part with an upper face visible from outside the extractor tube assembly, the top part being arranged above the insert,
wherein the elastomeric material encloses the insert and a portion of the top part of the gasket is adapted to be released from the insert when a pressure inside the beverage container exceeds a predetermined level so that fluid communication between an interior of the beverage container and the surroundings is provided, whereby the pressure is released from the beverage container, the gasket comprising an identification detectable from the upper face of the gasket so that it is easily detectable if a pressure release function of the gasket has been partly or fully initiated.

2. An extractor tube assembly according to claim 1, wherein the identification is a circle line arranged on or in the upper face of the gasket, or a plurality of graphical elements providing a circle which is easily detectable from the upper face.

3. An extractor tube assembly according to claim 1, wherein the identification has a color which is different from a color of the gasket in order to facilitate detection of the identification.

4. An extractor tube assembly according to claim 1, wherein the identification is part of the upper face.

5. An extractor tube assembly according to claim 1, wherein the identification is embedded in the upper face.

6. An extractor tube assembly according to claim 1, wherein the insert comprises a first tubular part extending in an axial direction of the gasket and a flange ring-shaped part extending radially from the tubular part towards a center of the insert, ending at an inner periphery, providing an open area around the center, the ring-shaped part comprising a plurality of incisions arranged around the inner periphery.

7. An extractor tube assembly according to claim 6, wherein the ring-shaped part comprises six first incisions and one second incision, the second incision being at least three times bigger than one of the first incisions, all the first and second incisions being arranged around the inner periphery.

8. An extractor tube assembly according to claim 6, wherein the tubular part has an outer face comprising one or more projections.

9. A beverage container comprising an extractor tube assembly according to claim 1.

10. A beverage dispensing system comprising:
a beverage container having an extractor tube assembly according to claim 1,
a dispense head adapted to be connected with the extractor tube assembly,
a gas supply being connected to the dispense head for supplying gas to the beverage container, and
a dispensing tap being connected with the dispense head via a dispensing line.

11. A beverage dispensing system according to claim 10, further comprising
a detector device adapted to detect the identification of the gasket and to receive information regarding the identification, and
a processing device adapted to extract the information regarding the identification to provide the information to a user.

12. A beverage dispensing system according to claim 11, wherein the detector device is connected with a communication unit which is adapted to communicate with a storage device, such as a server.

13. Use of the identification of the gasket of the extractor tube assembly according to claim 1 for controlling that the pressure release function of the gasket has not been partly or fully initiated.
